(19) United States
(12) Patent Application Publication
(10) Pub. No.: US 2015/0006388 A1
(43) Pub. Date: Jan. 1, 2015

(54) ELECTRONIC PAYMENT SYSTEMS AND METHODS INVOLVING A MOBILE DEVICE

(71) Applicant: Paul Myers, Carlsbad, CA (US)

(72) Inventor: Paul Myers, Carlsbad, CA (US)

(21) Appl. No.: 14/217,269

(22) Filed: Mar. 17, 2014

Related U.S. Application Data
(60) Provisional application No. 61/802,263, filed on Mar. 15, 2013.

(51) Int. Cl. G06Q 20/32; G06Q 20/22; G06Q 20/40

(52) U.S. Cl. CPC G06Q 20/3226; G06Q 20/40; G06Q 20/227
USPC 705/44

(57) ABSTRACT

Electronic payment systems and methods involving a mobile device are described, including a device-implemented method for issuing a payment, which includes requesting an authentication code; receiving the authentication code; sending a message to a device of a payee, the message comprising a payment amount and the authentication code; and receiving an acknowledgement of the payment amount.

### BACKGROUND

1. Field of Art

The subject matter discussed herein relates generally to electronic payments and, more particularly, to electronic payment systems and methods involving a mobile device.

2. Related Background

Transactions are conducted using increasing numbers of different forms of non-cash payment. There are numerous issuers of credit cards, merchant cards, gift cards, etc. To use these cards, a consumer has to carry them in his wallet or her purse. Charges on these cards, except the gift cards, will have to be settled with payments made individually to each issuer.

### BRIEF DESCRIPTION OF THE DRAWINGS

FIG. 1 shows an example payment flow diagram.

FIG. 2 shows a simplified consumer finance system.

FIG. 3 shows another simplified consumer finance system.

FIG. 4 shows an example payment.

FIG. 5 shows an example payment confirmation.

FIG. 6 shows an example consumer finance environment.

FIG. 7 shows an example device suitable for use in some example implementations.

FIG. 8 shows an example computing environment with an example computing device suitable for use in some example implementations.

### DETAILED DESCRIPTION

The subject matter described herein is taught by way of example implementations. Various details have been omitted for the sake of clarity and to avoid obscuring the subject matter. The examples shown below are directed to structures and functions for implementing electronic payment systems and methods involving a mobile device.

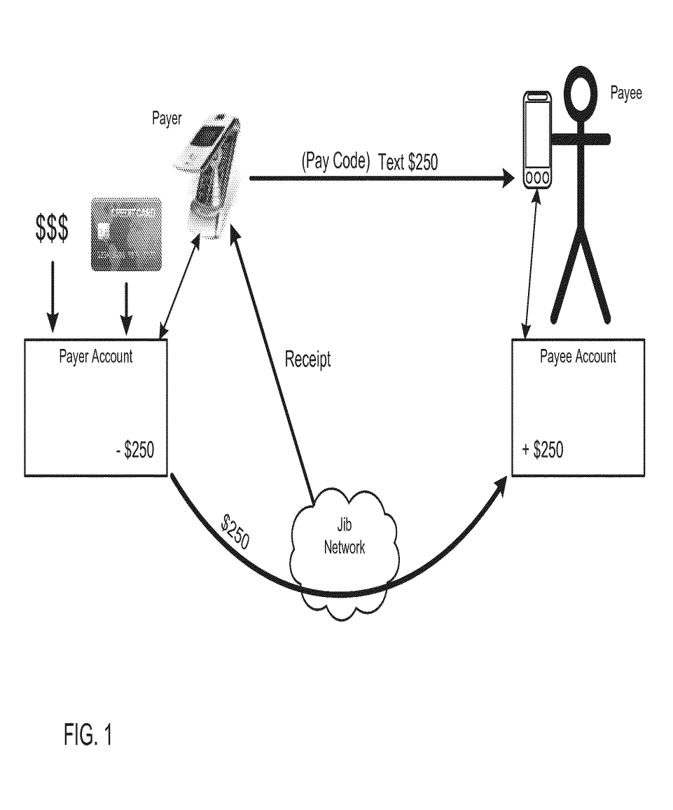

FIG. 1 shows an example payment flow diagram. A payer, which can be any person or entity (e.g., a corporation or organization), is shown paying a payee using a mobile device (e.g., a cellular telephone). The mobile device can be any device with the capability to send a text message (e.g., a short message service or SMS message). The example mobile device is shown as a simple flip phone. Sending payments or money via a text message requires only a device that can send a text message (e.g., a small phone or flip phone). A smartphone is not required.

To authenticate the payer, the mobile device interacts with a password setting mechanism or system for providing a password or authentication code for one time use (one-time password or OTP for short). For example, before initiating a payment, the payer accesses the OTP system (e.g., from the mobile device or another device) to request an OTP. The request may include where the OTP is to be received (e.g., the telephone number of the mobile device). The mobile device then receives a random OTP. The OTP may include a secret passcode that is known to the payer or associated with the payer (e.g., associated with the telephone number of the mobile device).

With the OTP, which is used here as an authorization of a payment (e.g., pay code), the payer may pay a payee by sending a text message. The text message includes a payment amount and the pay code. In some implementations, the pay code may be sent directly to the payee to authorize an incoming payment, in which case the payer's message does not need to, but can, include the pay code.

At some point after receiving the payment message, the Jib network provides a receipt. The receipt may be in the form of a text message back to the payer's device and/or another form of message (e.g., an email message to the payer). The payment receipt(s) may be provided as soon as the payer's payment message is received. In some implementations, a receipt may be provided after the payment has been confirmed (e.g., credited to the payee).

In some implementations, a receipt to the payer's mobile device may bundle with other offers, deals, loyalty, rewards, etc. In some implementations, the receipt may be provided after the payment is processed and settled based on the funds being in an account of the payer.

Payments are settled between two accounts on the payment network (referred to as a Jib network). For example, to send payments using the Jib network, a payer would have an account (e.g. checking, savings, etc.) and ensure that there is sufficient fund in the account. The account may be an account opened with and/or managed by the Jib network. The account may also be any account (e.g., an account with a financial institution) that the Jib network can withdraw funds from. If the payer's account is with the Jib network, the payer may deposit funds in the account with cash, checks, credit cards, fund transfer, direct deposit, etc.

The payer's account may be associated with an identifier the payer prefers to use in fund transactions (e.g., for issuing and/or receiving payments). For example, the payer may prefer to use his or her phone number or pseudo phone number as an identifier, because the phone number is unique and belong to the payer. The identifier or phone number may be associated with more than one payer accounts.

When a payment is communicated to a payee (e.g. a payment text message), information about the payment may be provided to the Jib network by the payer and/or payee. In some implementations, the payer may notify the Jib network of a payment (e.g., the mobile device of the payer automatically text the Jib network). In some implementations, the payee would notify the Jib network.

The Jib network then, based on the pay code and other information about the payer and payee, settles the payment by withdrawing fund in the payment amount from the payer's account and crediting the same amount to the payee's account. If the payee's account is not with the Jib network, the payment may be provided to the payee by an electronic fund transfer, a check, or in another form). In some implementations, there may be no fees for the payment. In other implementations, a small fee may be charged to the payer, payee, or both.

Payments with a mobile device in the Jib network may be made by any person or entity to any person or entity. Payments may be online payments and brick and mortar payments to retailers. For example, a shopper can send a text for the amount of a purchase to a shop (e.g. a device of the shop or a handheld device of the clerk of the shop). The point of sales (POS) application running on the shop's device or handheld device would recognize the payment via the Jib network and then issue a digital receipt to the shopper (e.g. as a text message to the shopper's device). The Jib network then processes the transaction and settles based on the funds being in an account of the shopper.

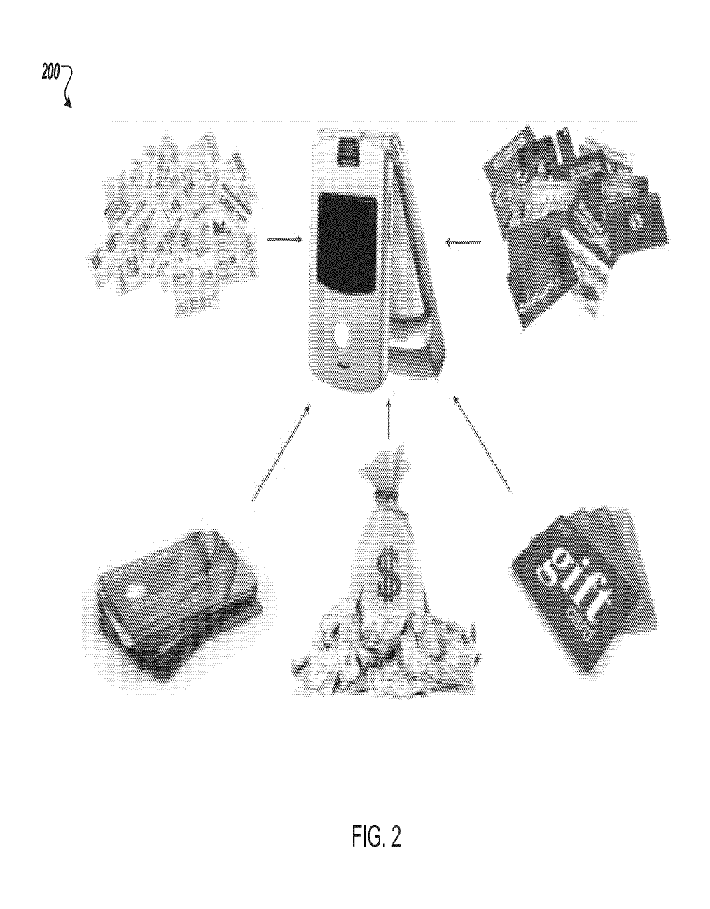

FIG. 2 shows a simplified consumer finance system. The Jib network enables more than mobile payments. Finance system 200 shows that the Jib network enables consumers to use a mobile device in the places of credit cards, cash, gift cards, merchant cards and coupons.

Instead of carrying credit cards and managing their activities (e.g., dealing with the monthly statements of different credit cards), a consumer (e.g. Alice) can merely use or her telephone number a pseudo phone number, which she always remembers and has with her.

Similarly, Alice does not need to carry cash, her checkbook, and merchants' cards. Alice can simply pay using her mobile device or using her phone numbers. For example, Alice is browsing the website of an online merchant with her mobile device (e.g., a smartphone). She sees an item she wants to buy and adds it to her online shopping cart. In the checkout process, rather than being required to enter all of her credit card and billing information, she merely enters her phone number and then receives an OTP to her mobile device, then enters the OTP online to complete her payment for the item to the merchant's system, receives a payment receipt or invoice via email and/or SMS. A day or two later, the item arrives to her doorstep or she can arrange to pick up the item.

Alice's Jib account, card, telephone number of her mobile device can be linked or loaded with gift cards, coupons, promotions, awards, rewards, rebates, etc. so that she does not have to carry them and remember their existence. Alice's mobile device—like card or QR code—is merely a “proxy” to initiate the transactions. The Jib network stores all of the gift cards, coupons, promotions, awards, rewards, rebates, etc. so that she does not have to carry them and remember their existence. In the shopping example above, if Alice has any gift card, coupon, promotion, etc. that can be used at the online shopper, her mobile device may alert Alice to used them in the purchase.

In some implementations, Alice may configure her Jib account, which is linked to her telephone number of her mobile device, to automatically apply any applicable gift cards, coupons, promotions, awards, rewards when she shops. For example, when Alice visits the website of merchant Y, her account through her mobile device may identify any gift card, coupon, promotion, etc. redeemable at merchant Y and bring them to Alice's attention. At checkout, the mobile device may automatically use or apply them to reduce Alice's payment and/or increase her benefits (e.g., receive a free promotional item for Alice).

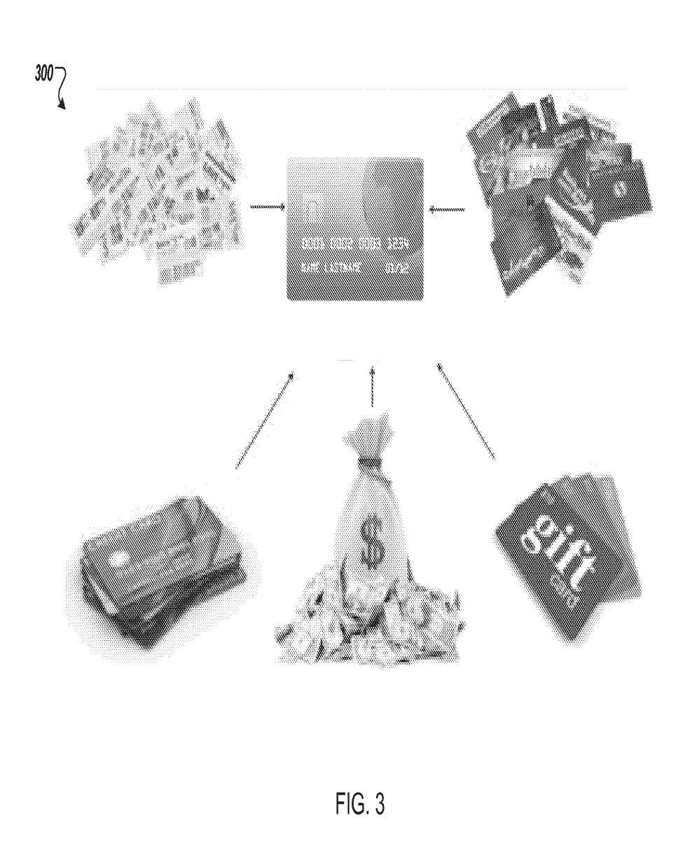

FIG. 3 shows another simplified consumer finance system. Finance system 300 differs from finance system 200 (FIG. 2) in using an item (e.g., a card) that is not a mobile phone to identify a consumer. Any item that can be used to identify a consumer can be used. The item can be a card (as shown), an near field communication (NFC) sticker, a radio-frequency identification (RFID) label, or a sticker with a quick response (QR) code, barcode, human readable number (e.g., a telephone number), etc.

In addition to payments by text or SMS messages, payments may be initiated by any form factors (e.g., those described above). For example, a payment can be initiated using a magnetic stripe card swipe, NFC tap, or QR code scan etc. A payment transaction whereupon the OTP would be sent to the appropriate mobile device associated with the Jib user's account in order to authenticate the user and therefore the transaction. As with respect to the mobile phone in FIG. 3, the card in FIG. 3 or any form used to identify a consumer is merely a “proxy.” For simplicity, the description herein refers to a mobile device or car. The features, benefits, advantages described are provided by the Jib network or Jib platform.

The card shown can be any type of card, such as a loyalty card, a magnetic stripe card, an NFC tag, RFID card, a card with an embedded chip and/or processor, etc. Similar to financial system 200, the card shown in the middle may be used in place of the items shown around it and more. For example, the card can be linked to an account and used in place of money, checks, credit cards, and debit cards. The card can be used as a merchant card at different merchants. As with the mobile device in financial system 200, gift cards, coupons, promotions, awards, rewards, rebates, etc. can be loaded onto or linked to the card (e.g., onto the magnetic stripe or other memory on the card on onto the account associated with the card).

A consumer may carry just the card without carrying the other surrounding items shown in FIG. 3. The consumer can use the card at any and all places where cash, checks, coupons, credit cards, debit cards, gift cards, and merchant cards are accepted.

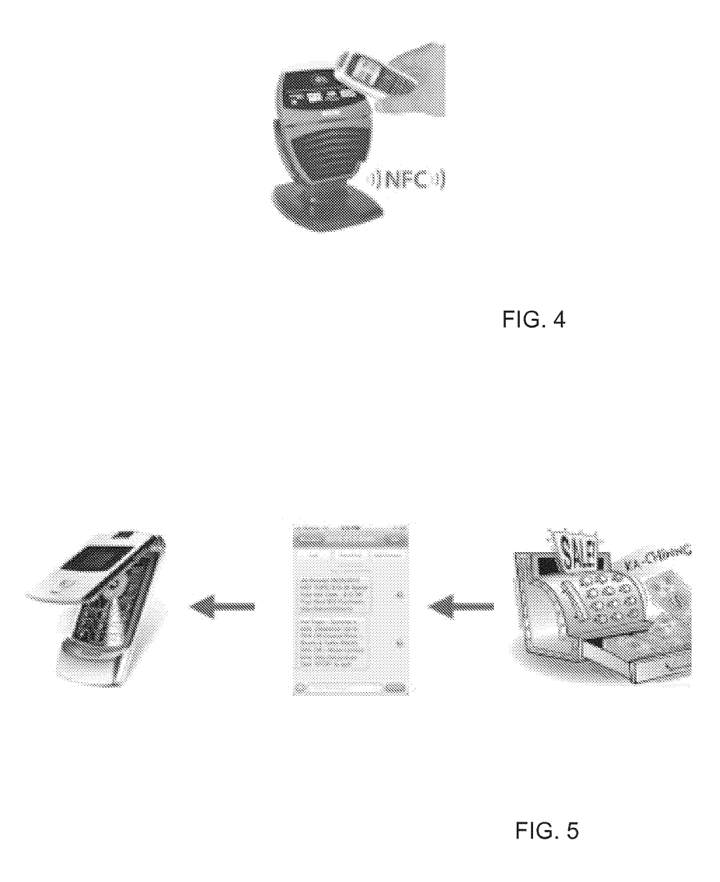

FIG. 4 shows an example payment. A payment is issued from an issuing device and received by a receiving device. The matching of an issuing device with a receiving device depends on the form of payment and/or technology used in the payment transaction. Here NFC technology is shown. To issue a payment using NFC, the issuing device or card includes an NFC chip. The receiving device reads information from the NFC chip when it is placed in close proximity but does not have to make contact.

In other examples, a consumer paying with a card (not shown) would meet with a card reader. QR code scanner, RFID reader, etc. are other receiving devices.

FIG. 5 shows an example payment confirmation. Here, a receipt or invoice is sent to a mobile phone (e.g., that of the purchaser or payer). The receipt may be sent by the Jib network and/or the merchant to show the transaction went through. In some implementations, the receipt include other information, such account balance, loyalty, rewards, offers, incentives, etc.

In some situations, the Jib network, based on a transaction with the merchant, may send a coupon, promotion notice, reward amount (marketing item) to a mobile phone (e.g., linked to or loaded onto the mobile phone). The Jib network may provide the marketing item in response to a purchase or simply to entice the user of the mobile device to patronize the merchant. For example, Alice is walking by a local cafe, and she gets a notification on her cellular phone that she will get a free bagel if she buys a cup of coffee.

In this example, the local cafe may be on the Jib network and may subscribe to notifications by the network that consumers matching a profile (e.g., provided by the local cafe) is in the vicinity of the merchant. When a consumer is within the provide perimeters, the Jib network then verifies that the consumer has opted into receiving promotion and/or marketing items. (The consumer can opt out of receiving such items any time.) When the above happen, a notification may be sent to the merchant notifying the merchant that a consumer matching your profile is within a distance from your store, and that the consumer has opted into receiving marketing items. The notification may include the consumer's information (e.g., telephone number) for sending such items. The merchant then send a coupon to the consumer's telephone number, which may a mobile device. In the above example, the local café sends Alice a coupon.

Alice then walks inside the local café and makes a purchase with her Jib account (e.g., by using her mobile phone or a card linked to the account). Alice may not even needs to perform a paying action to pay for the cup of coffee because the local café already knows who she is and who to charge for the cup of coffee. The bagel rings up as “free” with the cup of coffee ($2.50). Alice gets a receipt from Jib Network and/or a payment notification from her bank confirming she has been charged $2.50 for the coffee with a free bagel. The coffee may also be free under some situations. For example, if she had accumulated enough rewards or loyalty points to earn a free cup of coffee.

In some implementations, depending on the consumer's opt in settings, credits, coupons, deals, offers and/or rebates from a merchant may be sent to the consumer's email, social network(s), or postal mail, etc.

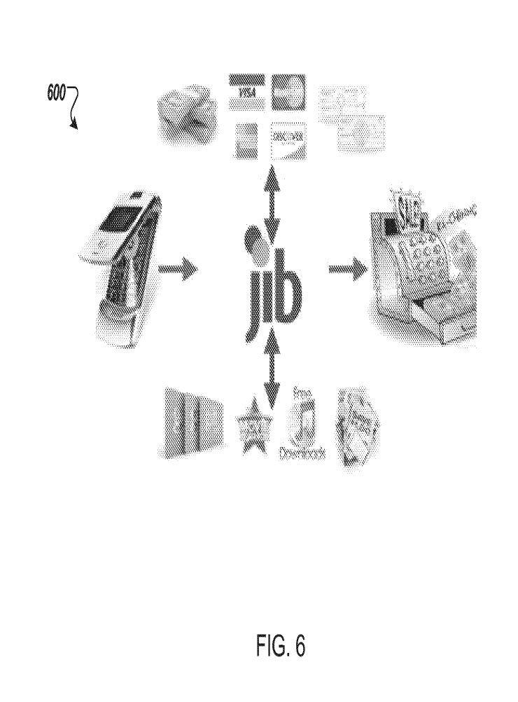

FIG. 6 shows an example consumer finance environment. Environment 600 sums up the description about. Environment 600 is shown with a mobile phone (on the left), but it can be any item that identifies a consumer (e.g., a card, as shown in FIG. 3). Environment 600 show a Jib Platform that links the various pieces together and that it is compatible with any consumer using any mobile device on any network at any merchant.

In addition to the features, benefits, and advantages described about, the Jib network provides and includes other advantages and benefits. For example, the Jib network enables different forms of loyalties, such as loyalty to a merchant (frequent shopper), loyalties across merchants, and others. The Jib network also provides opportunities to promote based on habits, profiles, and traits of consumers (subject to their consents).

In addition, the Jib network enables the merchants to provide better services (e.g., personalized services) to consumers. For example, Alice frequently drink coffee on Saturdays but teas on Sundays. When she visit a café for the first time in a tourist destination on a Sunday, the café, with a connection to the Jib network, is able to learn of Alice's preference for tea and offer her a cup of free tea with any purchase.

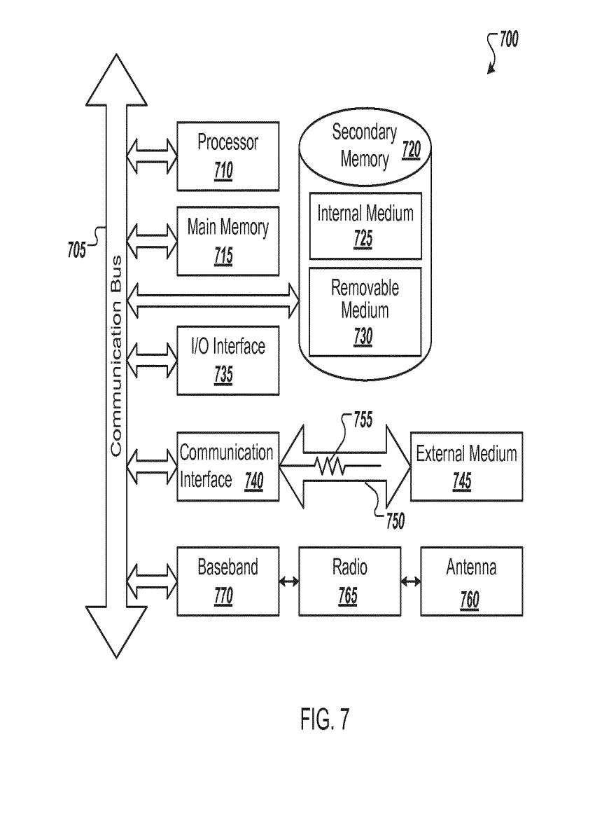

FIG. 7 shows an example device suitable for use in some example implementations. Device 700, a wired and/or wireless device, may be used in connection with various embodiments described herein. For example the device 700 may be used as or in conjunction with one or more of the mechanisms or processes described above, and may represent components of server(s), user system(s), and/or other devices described herein. The device 700 can be a mobile device, server, computer, or any other processor-enabled device that is capable of wired or wireless data communication. Other computer systems and/or architectures may be also used, as will be clear to those skilled in the art.

The device 700 preferably includes one or more processors, such as processor 710. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 710. Examples of processors which may be used with device 700 include, without limitation, the Pentium® processor, Core i7® processor, and Xeon® processor, all of which are available from Intel Corporation of Santa Clara, Calif.

The processor 710 is preferably connected to a communication bus 705. The communication bus 705 may include a data channel for facilitating information transfer between storage and other peripheral components of the device 700. The communication bus 705 further may provide a set of signals used for communication with the processor 710, including a data bus, address bus, and control bus (not shown). The communication bus 705 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Device 700 preferably includes a main memory 715 and may also include a secondary memory 720. The main memory 715 provides storage of instructions and data for programs executing on the processor 710, such as one or more of the functions and/or modules discussed above. It should be understood that programs stored in the memory and executed by processor 710 may be written and/or compiled according to any suitable language, including without limitation C/C++, Java, JavaScript, Pearl, Visual Basic, .NET, and the like. The main memory 715 is typically semiconductor-based memory such as dynamic random access memory (DRAM) and/or static random access memory (SRAM). Other semiconductor-based memory types include, for example, synchronous dynamic random access memory (SDRAM). Rambus dynamic random access memory (RDRAM), ferroelectric random access memory (FRAM), and the like, including read only memory (ROM).

The secondary memory 720 may optionally include an internal memory 725 and/or a removable medium 730, for example a floppy disk drive, a magnetic tape drive, a compact disc (CD) drive, a digital versatile disc (DVD) drive, other optical drive, a flash memory drive, etc. The removable medium 730 is read from and/or written to in a well-known manner. Removable storage medium 730 may be, for example, a floppy disk, magnetic tape, CD, DVD, SD card, etc.

The removable storage medium 730 may be a non-transitory computer-readable medium having stored thereon computer executable code (i.e., software) and/or data (e.g., for implementing at least a portion of the subject matter described herein). The computer software or data stored on the removable storage medium 730 is read into the device 700 for execution by the processor 710.

In alternative embodiments, secondary memory 720 may include other similar means for allowing computer programs or other data or instructions to be loaded into the device 700. Such means may include, for example, an external storage medium 745 and an interface 740. Examples of external storage medium 745 may include an external hard disk drive or an external optical drive, or and external magneto-optical drive.

Other examples of secondary memory 720 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 730 and communication interface 740, which allow software and data to be transferred from an external medium 745 to the device 700.

Device 700 may include a communication interface 740. The communication interface 740 allows software and data to be transferred between device 700 and external devices (e.g. printers), networks, or information sources. For example, computer software or executable code may be transferred to device 700 from a network server via communication interface 740. Examples of communication interface 740 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing device 700 with a network or another computing device.

Communication interface 740 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 740 are generally in the form of electrical communication signals 755. These signals 755 are preferably provided to communication interface 740 via a communication channel 750. In one embodiment, the communication channel 750 may be a wired or wireless network, or any variety of other communication links. Communication channel 750 carries signals 755 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 715 and/or the secondary memory 720. Computer programs can also be received via communication interface 740 and stored in the main memory 715 and/or the secondary memory 720. Such computer programs, when executed, enable the device 700 to perform the various functions, such as those described herein.

In this description, the term “computer readable medium” is used to refer to any non-transitory computer readable storage media used to provide computer executable code (e.g., software and computer programs) to the device 700. Examples of these media include main memory 715, secondary memory 720 (including internal memory 725, removable medium 730, and external storage medium 745), and any peripheral device communicatively coupled with communication interface 740 (including a network information server or other network device). These non-transitory computer readable mediums are means for providing executable code, programming instructions, and software to the device 700.

In an embodiment that is implemented using software, the software may be stored on a computer readable medium and loaded into the device 700 by way of removable medium 730, I/O interface 723, or communication interface 740. In such an embodiment, the software is loaded into the device 700 in the form of electrical communication signals 755. The software, when executed by the processor 710, preferably causes the processor 710 to perform the inventive features and functions previously described herein.

In an embodiment, I/O interface 723 provides an interface between one or more components of device 700 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The device 700 also includes optional wireless communication components that facilitate wireless communication over a voice and over a data network. The wireless communication components may comprise an antenna system 760, a radio system 76, a baseband system 770, or any combination thereof. In the device 700, radio frequency (RF) signals are transmitted and received over the air by the antenna system 760 under the management of the radio system 76.

In one embodiment, the antenna system 760 may comprise one or more antennae and one or more multiplexors (not shown) that perform a switching function to provide the antenna system 760 with transmit and receive signal paths. In the receive path, received RF signals can be coupled from a multiplexor to a low noise amplifier (not shown) that amplifies the received RF signal and sends the amplified signal to the radio system 765.

In alternative embodiments, the radio system 765 may comprise one or more radios that are configured to communicate over various frequencies. In one embodiment, the radio system 765 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 765 to the baseband system 770.

If the received signal contains audio information, then baseband system 770 decodes the signal and converts it to an analog signal. Then the signal is amplified and sent to a speaker. The baseband system 770 also receives analog audio signals from a microphone. These analog audio signals are converted to digital signals and encoded by the baseband system 770. The baseband system 770 also codes the digital signals for transmission and generates a baseband transmit audio signal that is routed to the modulator portion of the radio system 765. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 760 where the signal is switched to the antenna port for transmission.

The baseband system 770 is also communicatively coupled with the processor 710. The central processing unit 710 has access to data storage areas 715 and 720. The central processing unit 710 is preferably configured to execute instructions (i.e., computer programs or software) that can be stored in the memory 715 or the secondary memory 720. Computer programs can also be received from the baseband processor 760 and stored in the data storage area 715 or in secondary memory 720, or executed upon receipt. Such computer programs, when executed, enable the device 700 to perform the various functions, such as those described herein. For example, data storage areas 715 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory. ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

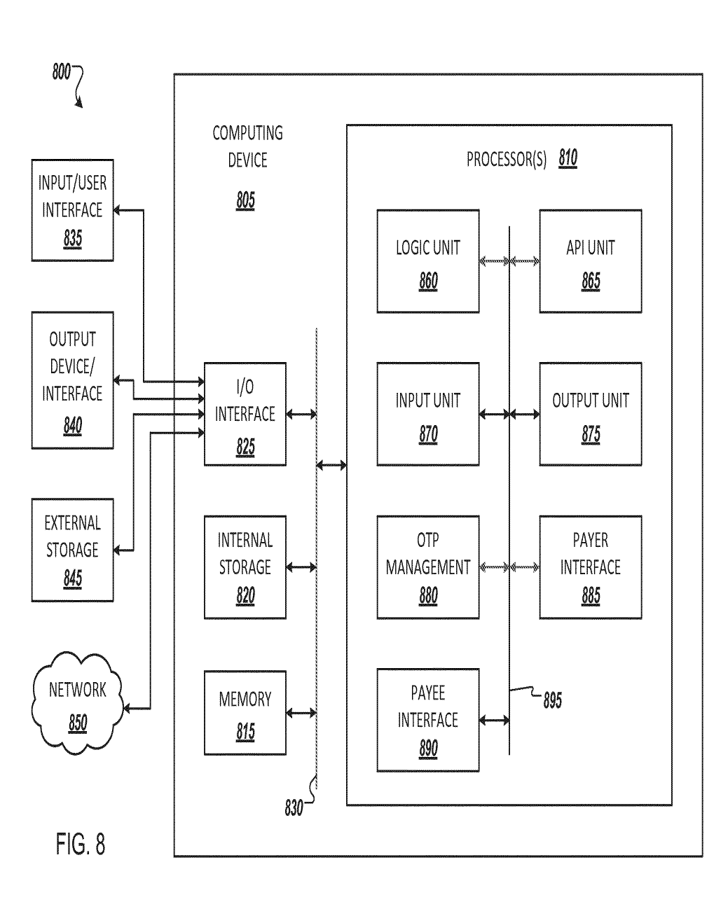

FIG. 8 shows an example computing environment with an example computing device suitable for use in some example implementations. Computing device 805 in computing environment 800 can include one or more processing units, cores, or processors 810, memory 815 (e.g., RAM. ROM, and/or the like), internal storage 820 (e.g. magnetic, optical, solid state storage, and/or organic), and/or I/O interface 825, any of which can be coupled on a communication mechanism or bus 830 for communicating information or embedded in the computing device 805.

Computing device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computing device 805. In other example implementations, other computing devices may function as or provide the functions of input/user interface 835 and output device/interface 840 for a computing device 805.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 805 can be communicatively coupled (e.g., via I/O interface 825) to external storage 845 and network 850 for communicating with any number of networked components, devices, and systems, including one or more computing devices of the same or different configuration. Computing device 805 or any connected computing device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g. CD ROM, digital video disks, Blu-ray disks), solid state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#. Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, OTP managment 880, payer interface 885, payee interface 890, and inter-unit communication mechanism 895 for the different units to communicate with each other, with the OS, and with other applications (not shown). For example, OTP managment 880, payer interface 885, and payee interface 890 may implement one or more processes described and/or shown in FIGS. 1-6 above. The described units and elements can be varied in design, function, configuration, or implementation and are not limited to the descriptions provided.

In some example implementations, when information or an execution instruction is received by API unit 865, it may be communicated to one or more other units (e.g., logic unit 860, input unit 870, output unit 875. OTP managment 880, payer interface 885, and payee interface 890). For example, the OTP managment 880 may interface with output unit 875 to request an authentication code, which may be received by input unit 870 before passing to OTP managment 880. The payer interface 885 may then send a message via output unit 875 to a device of a payee. The payee interface 890 may then receive via input unit 870, an acknowledgement of the payment amount.

When device 805 is used in receiving payments, the payment may be received through input unit 870 before passing it to payee interface 890 (after determined by logic unit 860).

In some instances, logic unit 860 may be configured to control the information flow among the units and direct the services provided by API unit 865, input unit 870, output unit 875, OTP managment 880, payer interface 885, and payee interface 890 in some example implementations described above. For example, the flow of one or more processes or implementations may be controlled by logic unit 860 alone or in conjunction with API unit 865.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city. ZIP code, or state level), so that a particular location of a user cannot be determined. Thus, the user may have control over how information is collected about the user and used by a content server.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A device-implemented method for issuing a payment, comprising:
requesting an authentication code;
receiving the authentication code;
sending a message to a device of a payee, the message comprising a payment amount and the authentication code; and
receiving an acknowledgement of the payment amount.
